(19) United States
(12) Patent Application Publication
(10) Pub. No.: US 2021/0180349 A1
(43) Pub. Date: Jun. 17, 2021

(54) Stud Manipulation Tool

(71) Applicant: Billy Dandurand, Healy, KS (US)

(72) Inventor: Billy Dandurand, Healy, KS (US)

(21) Appl. No.: 17/123,221

(22) Filed: Dec. 16, 2020

Related U.S. Application Data
(60) Provisional application No. 62/948,588, filed on Dec. 16, 2019.

(51) Int. Cl. E04G 21/18; B25G 1/10

(52) U.S. Cl. CPC E04G 21/1841; B25G 1/102

(57) ABSTRACT

A stud manipulation tool is provided. The device includes a planar base having a pair of sidewalls extending orthogonally from opposing sides of the planar base, defining a channel therebetween. An aperture is disposed through one of the pair of sidewalls. A clamp is engaged with the aperture such that the clamp can frictionally engage an object disposed within the channel. An elongated rod extends from an exterior surface of the planar base opposite the channel. In some embodiments, pair of sidewalls extend from the planar base at an acute angle, such that a linear distance between an upper end of each sidewall is less than a width of the planar base.

### CROSS REFERENCE TO RELATED APPLICATIONS

This application claims the benefit of U.S. Provisional Application No. 62/948,588 filed on Dec. 16, 2019. The above identified patent application is herein incorporated by reference in its entirety to provide continuity of disclosure.

### BACKGROUND OF THE INVENTION

The present invention relates to stud manipulation tools. More particularly, the present invention pertains to a stud manipulation tool having an elongated rod extending therefore, such that the user can twist the stud to aid in removal or alignment of the stud.

When framing walls and decks, studs must be twisted or otherwise manipulated to be properly aligned before being secured to the remainder of the frame. This often requires multiple individuals to ensure that the studs are properly aligned. Unfortunately, this often represents an undesirable usage of manpower on a worksite, causing the overall task to take longer than desired to complete. Additionally, human error can still result in uneven alignment of studs within the frame, which may require the entire process to be restarted, resulting in further inefficiencies. Furthermore, when disassembling a wall or otherwise removing a stud, it is often required that the stud be twisted from the frame to prevent further damage to the assembly. Typical tools that can be used to grip and manipulate studs, joists, or the like, such as wrenches, can damage and split the wood, forcing the wood to be replaced. Frequent damage can result in undue expense. Additionally, frames, rafters, joists, and the like may fall without proper support during assembly, potentially resulting in injury to the individual assembling the frame. Therefore, a device that can easily and efficiently manipulate studs during installation or disassembly while also supporting a frame during assembly is desired.

In light of the devices disclosed in the known art, it is submitted that the present invention substantially diverges in design elements from the known art and consequently it is clear that there is a need in the art for an improvement to existing stud manipulation tools. In this regard, the instant invention substantially fulfills these needs.

### SUMMARY OF THE INVENTION

In view of the foregoing disadvantages inherent in the known types of stud manipulation tools now present in the known art, the present invention provides a stud manipulation tool wherein the same can be utilized for providing convenience for the user when twisting an existing stud to remove it or align it during installation.

The present system comprises a planar base having a pair of sidewalls extending orthogonally from opposing sides of the planar base, defining a channel therebetween. In some embodiments, the pair of sidewalls extend from the planar base at an acute angle, such that a linear distance between an upper end of each of the pair of sidewalls is less than a width of the planar base. An aperture is disposed through one of the pair of sidewalls. A clamp is engaged with the aperture and is configured to frictionally engage an object disposed within the channel. An elongated rod extends from an exterior surface of the planar base opposite the channel.

In some embodiments, a plurality of teeth is disposed on an interior surface of each of the pair of sidewalls. In another embodiment, a grip is disposed over a distal end of the elongated rod, wherein the grip extends along a length of the elongated rod. In some such embodiments, the grip comprises an ergonomic grip having a plurality of finger wells therein. In other embodiments, a distal end of the elongated rod comprises a planar surface. In yet another embodiment, the clamp comprises a threaded bolt having a handle perpendicularly affixed thereto, wherein the threaded bolt is configured to engage with interior threading disposed through the aperture. In some embodiments, a neck extends from one of the pair of sidewalls opposite the channel about the aperture. In another embodiment, the neck further comprises interior threading configured to engage complementary threading disposed on the clamp.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the stud manipulation tool.

FIG. 2A shows an end view of an embodiment of the stud manipulation tool.

FIG. 2B shows an end view of an alternate embodiment of the stud manipulation tool.

FIG. 3 shows a close-up view of the elongated rod of an embodiment of the stud manipulation tool.

FIG. 4 shows a cross-sectional view of an embodiment of the stud manipulation tool.

FIG. 5 shows a perspective view of an embodiment of the stud manipulation tool in use.

### DETAILED DESCRIPTION OF THE INVENTION

Reference is made herein to the attached drawings. Like reference numerals are used throughout the drawings to depict like or similar elements of the stud manipulation tool. The figures are intended for representative purposes only and should not be considered to be limiting in any respect.

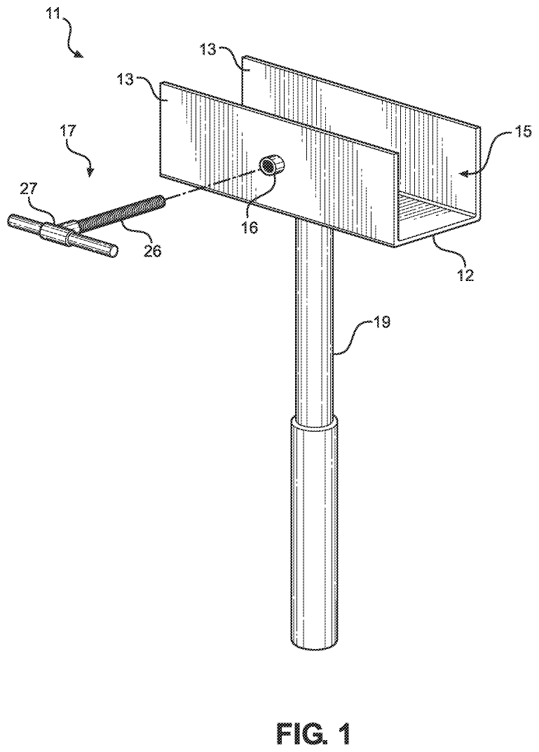

Referring now to FIG. 1, there is shown an exploded view of an embodiment of the stud manipulation tool. The stud manipulation tool 11 comprises a planar base 12 having a pair of sidewalls 13 extending from opposing sides of the planar base 12, thereby defining a channel 15 therebetween. The channel 15 is dimensioned to receive a stud, joist, beam, or other lumber therein. In one embodiment, the planar base 12 and the pair of sidewalls 13 comprise a unitary structure to provide increased structural stability, while in alternate embodiments, the pair of sidewalls 13 are affixed to the planar base 12, such as via welding. The pair of sidewalls 13 and the planar base 12 further comprise a rigid material, such that the stud manipulation tool 11 does not deform during use.

An elongated rod 19 is affixed to an exterior of the planar base 12 opposite the channel 15. The elongated rod 19 is configured to provide the user a gripping surface for twisting or otherwise manipulating a stud or other lumber affixed within the channel 15. Various lengths of elongated rod 19 are contemplated, such that the user can apply sufficient torque to the stud or other lumber to be manipulated as desired. In the shown embodiment, the elongated rod 19 is disposed equidistantly from each end of the planar base 12. In this manner, forces applied via the elongated rod 19 are evenly distributed across the stud disposed within the channel 15.

A clamp 17 is removably securable to the pair of sidewalls 13 via an aperture 16 through one sidewall of the pair of sidewalls 13. The clamp 17 is configured to extend into the channel 15 to frictionally engage a stud therein, such that the stud is secured between the clamp 17 and an opposing sidewall of the pair of sidewalls 13. In the illustrated embodiment, the clamp 17 comprises a threaded rod 26 perpendicularly affixed to a handle 27 along a midpoint thereof, wherein the threaded rod 26 engages threads disposed within the aperture 16. The handle 27 provides a gripping surface, allowing the user to selectively tighten or loosen the clamp 17 by hand. In this manner, supplemental tools, such as wrenches, are not necessary to secure the lumber within the channel 15, as the forces applied via supplemental tools can damage or split the lumber.

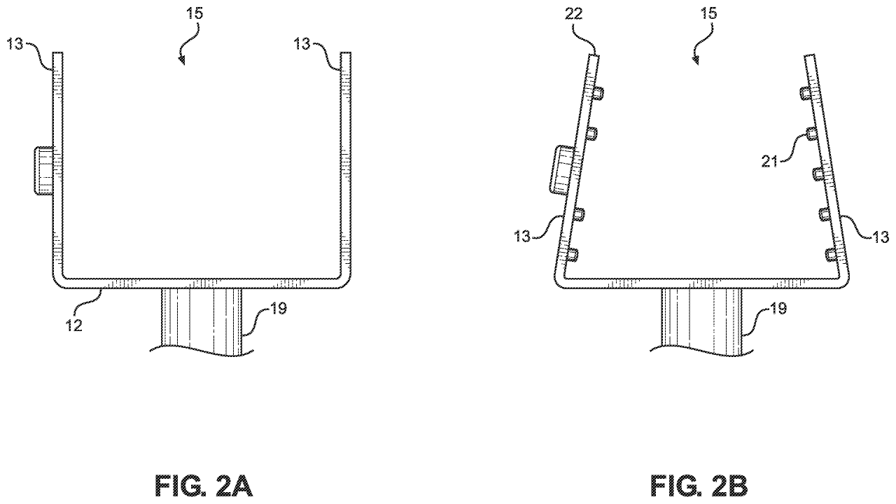

Referring now to FIGS. 2A and 2B, there is shown an end view of an embodiment of the stud manipulation tool and an end view of an alternate embodiment of the stud manipulation tool, respectively. In the illustrated embodiment of FIG. 2A, the pair of sidewalls 13 extend orthogonally from the planar base 12 defining a substantially rectangular channel 15 therebetween. In this manner, the channel 15 is dimensioned to conform to the shape of studs or other lumber to ensure that at least one of the pair of sidewalls 13 rests flush against the stud affixed within the channel 15. Upon the application of force via the elongated rod 19, the force is then evenly distributed through the pair of sidewalls 13 to manipulate the stud in a desired way while minimizing the risk of damage thereto.

In the shown embodiment of FIG. 2B, the pair of sidewalls 13 extend from the planar base 12 at an acute angle such that a distance between an upper end 22 of each of the pair of sidewalls 13 is less than a width of the planar base 12. In this manner, the channel 15 is dimensioned to more securely grip a stud inserted therein. Furthermore, the angled nature of the pair of sidewalls 13 allows additional force to be applied to the stud. Additionally, in the shown embodiment, a plurality of teeth 21 are affixed to an interior surface of each of the pair of sidewalls 13, wherein the plurality of teeth 21 are configured to increase the surface area in contact with a stud within the channel 15, such that frictional engagement therewith is increased. In some embodiments, the plurality of teeth 21 comprise a rounded tip, such that the plurality of teeth 21 are incapable of puncturing the stud, thereby minimizing damage thereto. The plurality of teeth 21 are contemplated to extend along an entirety of the interior surfaces of the pair of sidewalls 13. In some embodiments, the plurality of teeth 21 are disposed in a staggered distribution to increase the surface area covered thereby.

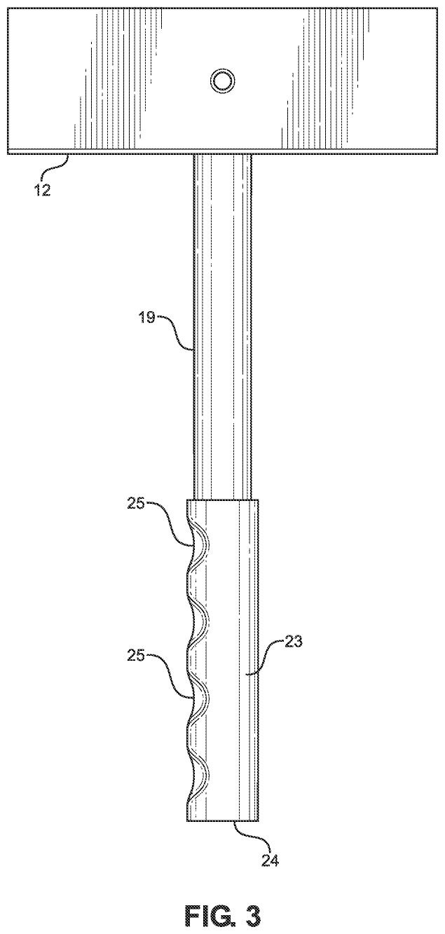

Referring now to FIG. 3, there is shown a close-up view of the elongated rod of an embodiment of the stud manipulation tool. In the illustrated embodiment, a grip 23 is disposed over the elongated rod 19. The grip 23 is configured to conform to the elongated rod 19. In some embodiments, the grip 23 comprises a compressible material configured to increase the user's comfort during use. In the shown embodiment, the grip 23 further comprises an ergonomic design having a plurality of finger wells 25 therein. The plurality of finger wells 25 further increase frictional engagement with the user while increasing the user's comfort and control of the device during use. Furthermore, in the illustrated embodiment, a distal end 24 of the elongated rod 19 comprises a planar surface, such that the elongated rod 19 can rest flush against a support surface. In the shown embodiment, the distal end 24 comprises a planar surface parallel to the planar base 12. Similarly, as the grip 23 conforms to the elongated rod 19, the grip 23 along the distal end 24 also comprises a planar surface. In this manner, when a user is assembling a frame, the user can secure multiple stud manipulation tools to the frame and support the frame above a support surface via the elongated rod 19.

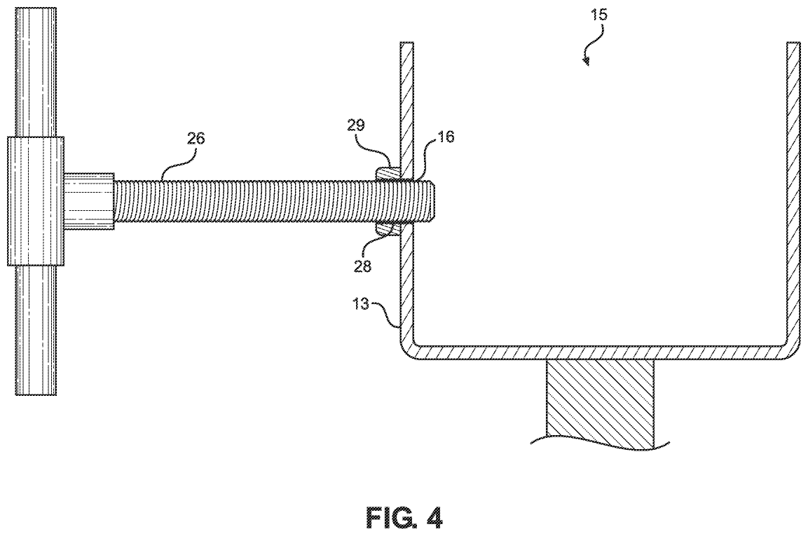

Referring now to FIG. 4, there is shown a cross-sectional view of an embodiment of the stud manipulation tool. In the illustrated embodiment, a neck 29 extends from a sidewall of the pair of sidewalls 13 opposite the channel 15 about the aperture 16. The neck 29 functionally extends the length of the aperture 16, thereby providing additional support and stability to the threaded rod 26 of the clamp during use. In the shown embodiment, complementary threading on the threaded rod 26 engages interior threading 28 extending through the neck 29 and the aperture 16 to allow the user to selectively extend the threaded rod 26 into the channel 15 to clamp a stud therein.

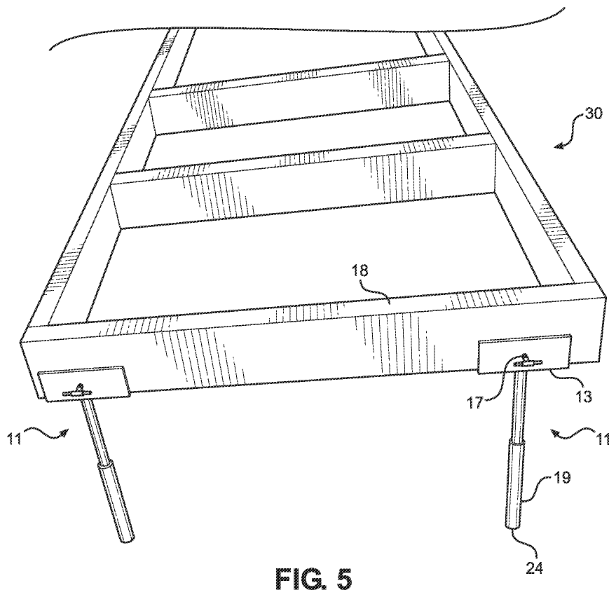

Referring now to FIG. 5, there is shown a perspective view of an embodiment of the stud manipulation tool in use. In one use, the stud manipulation tool 11 is secured to a stud 18 or other lumber. The stud 18 is inserted into the channel defined between the pair of sidewalls 13 and secured within the channel via actuation of the clamp 17. Once secured, the user can grasp the elongated rod 19 and apply torque to the stud manipulation tool 11 to twist the stud 18 within the channel. Once the stud 18 is positioned in a desired location, the user can then secure the stud 18 to a frame 30. Alternatively, should the user wish to remove the stud 18 from an existing frame 30, the user can twist the stud 18 with sufficient force to split the stud 18 along the connection point with the frame 30 allowing the stud 18 to be removed. In the shown embodiment, several stud manipulation tools 11 can further be utilized as a support elevating the frame 30 above a support surface via the planar distal end 24 of the elongated rod 19. In this manner, the user can assemble the frame 30 in an elevated position or retain the frame 30 elevated at a desired height to secure the frame 30 to a building or other structure.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A stud manipulation tool, comprising:
a planar base having a pair of sidewalls extending orthogonally from opposing sides of the planar base, defining a channel therebetween;
an aperture disposed through one of the pair of sidewalls;
a clamp engaged with the aperture and configured to frictionally engage an object disposed within the channel; and
an elongated rod extending from an exterior surface of the planar base opposite the channel.

2. The stud manipulation tool of claim 1, further comprising a plurality of teeth disposed on an interior surface of each of the pair of sidewalls.

3. The stud manipulation tool of claim 1, further comprising a grip disposed over a distal end of the elongated rod, wherein the grip extends along a length of the elongated rod.

4. The stud manipulation tool of claim 3, wherein the grip comprises an ergonomic grip having a plurality of finger wells therein.

5. The stud manipulation tool of claim 1, wherein a distal end of the elongated rod comprises a planar surface.

6. The stud manipulation tool of claim 1, wherein the clamp comprises a threaded bolt having a handle perpendicularly affixed thereto, wherein the threaded bolt is configured to engage with interior threading disposed through the aperture.

7. The stud manipulation tool of claim 1, further comprising a neck extending from one of the pair of sidewalls opposite the channel about the aperture.

8. The stud manipulation tool of claim 7, wherein the neck further comprises interior threading configured to engage complementary threading disposed on the clamp.

9. A stud manipulation tool, comprising:
a planar base having a pair of sidewalls extending from opposing sides of the planar base, defining a channel therebetween;
wherein the pair of sidewalls extend from the planar base at an acute angle, such that a distance between an upper end of each of the pair of sidewalls is less than a width of the planar base;
an aperture disposed through one of the pair of sidewalls;
a clamp engaged with the aperture and configured to frictionally engage an object disposed within the channel; and
an elongated rod extending from an exterior surface of the planar base opposite the channel.

10. The stud manipulation tool of claim 9, further comprising a plurality of teeth disposed on an interior surface of each of the pair of sidewalls.

11. The stud manipulation tool of claim 9, further comprising a grip disposed over a distal end of the elongated rod, wherein the grip extends along a length of the elongated rod.

12. The stud manipulation tool of claim 11, wherein the grip comprises an ergonomic grip having a plurality of finger wells therein.

13. The stud manipulation tool of claim 9, wherein a distal end of the elongated rod comprises a planar surface.

14. The stud manipulation tool of claim 9, wherein the clamp comprises a threaded bolt having a handle perpendicularly affixed thereto, wherein the threaded bolt is configured to engage with interior threading disposed through the aperture.

15. The stud manipulation tool of claim 9, further comprising a neck extending from one of the pair of sidewalls opposite the channel about the aperture.

16. The stud manipulation tool of claim 15, wherein the neck further comprises interior threading configured to engage complementary threading disposed on the clamp.
